(19) United States
(12) Patent Application Publication
(10) Pub. No.: US 2005/0104363 A1
(43) Pub. Date: May 19, 2005

(54) Process for forensic tissue rehydryation and finger ridge enhancement

(75) Inventors: Kimberly R. Wright, Hattiesburg, MS (US); Dean J. Bertram, Hattiesburg, MS (US)

Correspondence Address: Howrey Simon Arnold and White LLP, 750 Bering, Houston, TX, 77057, US

(73) Assignee: University of Southern Mississippi

(21) Appl. No.: 10/945,317

(22) Filed: Sep. 20, 2004

Related U.S. Application Data
(60) Provisional application No. 60/505,815, filed on Sep. 25, 2003.

(51) Int. Cl. B42D 15/00

(52) U.S. Cl. 283/68

(57) ABSTRACT

This invention relates to a process for the rehydration of tissues, comprising obtaining a tissue sample, heating a solution of tissue enhancing solution that does not contain flammable or toxic fluids or compounds to 35-70° C., exposing the tissue to the warm solution, and waiting for a period of time for the tissue to rehydrate and the ridge line details to be returned substantially to normal. As a result of this process, excellent fingerprints, hand prints, sole prints, lip prints, and the like can be obtained. Further, improved tissue clarity results from the rehydration process allow for the appropriate analysis using standard forensic techniques.

This application claims the benefit of provisional application Ser. No. 60/505,815 filed Sep. 25, 2003.

### FIELD OF THE INVENTION

The invention relates to forensic pathology and, more specifically, to processes for enhancing the quality of fingerprints retrieved from an individual. In particular, a process for the rehydration of tissue and fingerprint ridge enhancement is disclosed.

### DESCRIPTION OF RELATED ART

The dermatoglyphic pattern of human and animal skin, lips, palms, soles, and fingers is individually unique and unchanging, except in the case of damage or rare diseases. For this reason, the prints of palms, fingers, toes, lips, and soles of the feet have long been used in the identification of individuals, especially criminals. Sole prints have been used in the identification of newborn babies. Postmortem fingerprinting as a method of confirming or establishing identity is also well known. In the prints, particularly fingerprints, the papillary ridges appear as papillary lines. Between the papillary lines, prints of ridge fragments can be found again and again; they distinguish themselves from papillary lines by their varying widths. These lines of the print stem from the interpapillary or interstitial ridges.

However, extremely mummified, decayed, burned, or chemically damaged tissues fingers, toes and the like present the unique problem of softening the tissue, and in doing so eliminating the wrinkles and crevices in the tissue which resulted from the dehydration, burn damage, and/or mummification. In order for a fingerprint or tissue identification system to be commercially acceptable, it must be extremely stable and reliable. The prints obtained must be distinct and clear, and be easily readable by the human eye and by automated fingerprint reading systems, which are finding increased used especially within forensic and law enforcement agencies. Furthermore, the prints obtained must form very rapidly, and must possess a high degree of stability toward temperature, humidity, and light. The systems must also be simple, easy to use, and aesthetically inoffensive.

Several methods for tissue rehydration and/or fingerprint ridge enhancement have been described in the forensic literature. Perhaps one of the earliest of such methods was described by Ruffer in 1921, wherein a study published in “Studies in the Palaeopathology of Egypt” (University of Chicago Press) relating to Egyptian mummies described several tissue rehydration techniques related to the mummies. The Ruffer rehydration method included the use of alcohol, water, and a 5% solution of sodium carbonate. This rehydration solution was later modified by Walker et al. (American Journal of Physical Anthropology, 1987; 72: 43-48) for use in the rehydration of mummified pleural tissues. Most recently, the application of the Ruffer method for tissue rehydration has been applied to restoration of a mummified human fingertip to the degree that fingerprints could be taken from its surface (Schmidt, et al., Journal of Forensic Sciences, 1999, p. 874-875).

Similarly, hypodermic injection of tissue builders such as Hydrol (Hydrol Chemical Company, Yeadon, Pa.) (a toxic, viscous gel) or other similar fluids into supporting soft tissues to overcome the problem of crevices and wrinkles has become a routine method of practice (see, Practical Homicide Investigation, Elsevier Science Publishing Co., New York, 1984; pp. 190-193).

However, while many of these methods for tissue rehydration were useful to some degree, many possess significant drawbacks as well as failing to soften tissues adequately and/or destroying ridge detail during the process. For example, some require the use of harsh detergents and/or other similar chemicals (e.g., fabric softener) that can destroy cutaneous tissue by swelling and breaking up the epidermis (Rees, et al., Fingerprint Whorl, 1981, p. 39; Turner, P. J. and Holtom, D. B., Stain Technology 1981, pp. 35-38). Other methods rely heavily on relatively uncommon and/or expensive chemicals such as disodium ethylenediamine tetracetic acid, and/or required a great deal of work in order to obtain useable results (Zugibe, F. T. and Costello, J. T., Journal of Forensic Sciences 1986, pp. 726-731). Further methods, while seemingly simple, were not readily transferred out of the laboratory to the crime scene. All of these described methods possess the additional drawbacks of needing constant monitoring, solution preparation and solution stability, pH adjustments, and/or dissection of the tissue or finger pads themselves.

Haglund described the use of the combination of Metaflow (The Dodge Company, Cambridge, Mass.), an embalming preinjection fluid containing formaldehyde, and Restorative (The Dodge Company, Cambridge, Mass.), a viscous, biopolymer-based fluid used by morticians to rehydrate desiccated tissue (Journal of Forensic Sciences, 1988, pp. 1244-1248). However, this method too suffers from requiring the use of difficult to obtain and use solutions containing hazardous chemicals (formaldehyde).

Thus, there exists a need for a process to rehydrate tissue and enhance prints, especially fingerprint ridges on both cadavers and live individuals, that is easy to use, does not involve the use of toxic chemicals or reagents, produces rapid results, and has the ability to be used at a crime scene as well as in the laboratory.

### SUMMARY OF THE INVENTION

It is an object of the present disclosure to provide a process for rehydrating tissue, comprising the steps of warming a rehydrating solution to a temperature and injecting the heated rehydrating solution into a tissue.

It is a further aspect of the present disclosure to provide a process for enhancing tissue print ridge detail, comprising the steps of warming a rehydrating solution to a temperature and exposing a body part to the warm rehydrating solution, wherein the exposure can be by injection or by soaking.

These and other additional objects and advantages of this disclosure will be readily understood from a consideration of the drawings and the following detailed description of the preferred embodiments.

### DESCRIPTION OF THE FIGURES

The following figures form part of the present specification and are included to further demonstrate certain aspects of the present invention. The invention may be better understood by reference to one or more of these figures in combination with the detailed description of specific embodiments presented herein.

FIG. 1 shows the digit of a burn victim prior to tissue rehydration treatment in accordance with the present disclosure.

FIG. 2 shows the digit of the burn victim of FIG. 1 after tissue rehydration treatment in accordance with the present disclosure.

FIG. 3 shows the epidermal fingerprint obtained from the digit in FIG. 1.

FIG. 4 shows the epidermal print obtained from the digit shown in FIG. 2, following rehydration.

### DEFINITIONS

The following definitions are provided in order to aid those skilled in the art in understanding the detailed description of the present invention.

The term “body”, as used herein, refers to both cadavers and living species, and relates to mammals such as humans or other similar animals.

The term “rehydrating solution”, as used herein, shall refer to any suitable buffered solution which does not contain alcohol and does not contain toxic chemicals.

The term “print”, as used herein, refers to the combination of patterns, ridge endings and ridge separations of a tissue that are highly individualized and not altered with time. The term “print” as used herein encompasses “fingerprints”, such as those from any of the digits of a body, “footprints”, such as those taken of newly born babies and placed on birth records, “toeprints” such as those obtained from the individual toes of a body, “lip prints” such as those obtained from the lips of an individual, and “noseprint” such as those taken of animals, as well as any combination thereof.

### DETAILED DESCRIPTION OF THE INVENTION

One aspect of the present disclosure relates to a process for rehydrating skin tissue of a body, particularly the tissue of cadavers, for use in forensic identification. In particular, and according to such a process, a tissue is procured as appropriate, and is to prepared for rehydration. A rehydration solution that does not contain alcohol and is non-toxic is heated to a temperature of between about 35° C. and about 70° C., and the tissue to be rehydrated is exposed to the heated solution. Optionally, and equally acceptable, the rehydration solution can be carried pre-loaded in a syringe or other suitable exposure device, and heated to the desired temperature using a suitable heating means.

A further embodiment of the process of the present disclosure relates to a process for enhancing the fingerprint ridge detail of a finger or fingers on both cadavers and on living individuals by tissue rehydration. According to this process, after procuring a finger or fingers, a rehydrating solution that does not contain alcohol and is non-toxic is heated to a temperature between 35° C. and 70° C., and the finger(s) are exposed to the heated solution for a period of time. Exposure can be by direct injection of the solution into the fingertips themselves or by soaking in the heated solution, so as to enhance the ridge detail of the tissue.

The tissue to be used with the present invention can be any tissue which is dehydrated or otherwise damaged, including autopsy tissues, organs, mummified tissues including fingers, hands and toes, lips, burned tissues such as burned fingers, and the like. Also suitable for use with the present invention are chemically damaged tissues, such as those resulting from chemical burns, and environmentally damaged tissues, such as those tissues damaged by exposure to the elements, like wind and extreme cold.

The rehydrating solution used in accordance with the present disclosure is any suitable rehydrating solution that is non-toxic, does not contain alcohol or other potentially flammable fluids, and does not contain other possibly harmful chemicals, such as formaldehyde. Consequently, commercially available tissue-building solutions such as Hydrol Tissue Builder (Hydrol, Yeardon, Pa.), Metaflow (The Dodge Company, Cambridge, Mass.), and other related solutions often used in the mortuary sciences cannot be used with the present invention as they contain both alcohol (flammable) and formaldehyde (toxic). Preferably, the rehydrating solution is a pH balanced, aqueous, salt-buffered solution containing a low- or non-toxic biocide and/or stabilizer in effective amounts. Examples of suitable rehydrating solutions that do not contain alcohol include Antigen Retrieval Solution, which typically contains a sodium carbonate buffer, and Tissue Enhancing Solution (BioCare Medical, Walnut Creek, Calif.), also known as TES, which contains a citric acid buffered salt solution. Tissue Enhancing Solution is preferred for use with the present disclosure.

The rehydrating solution, according to the process of the present invention, is preferably heated to a temperature of at least about 35° C. prior to being exposed to the tissue to be rehydrated. Accordingly, solutions containing alcohol or other similarly flammable fluids should not be used due to flammability issues. Preferably, the rehydrating solution is heated, using any acceptable heating means, to a temperature between about 35° C. and about 70° C. More preferably, the rehydrating solution is heated to a temperature between about 50° C. and about 60° C. before use. For example, the rehydrating solution can be heated to a temperature of about 35° C., about 40° C., about 45° C., about 50° C., about 55° C., about 60° C., about 65° C., about 70° C., and to ranges between any two of these temperature values. Generally, the temperature of heating used in accordance with the present disclosure depends upon the degree of dehydration present in the tissue.

While not wishing to be held to any particular theory, it is believed that by heating the rehydrating solution prior to exposing the tissue to it, the warm solution more readily relaxes the skin, tissues, and associated cells and consequently allows for the identifying ridges and surrounding tissue to be rehydrated much more rapidly than if no heating was done.

As suggested above, it is preferred that the tissue rehydrating solution is heated to a temperature range of about 35° C. to about 70° C. prior to exposing the tissue to the solution. This can be accomplished by any acceptable heating means known to those of skill in the art. For example, in the laboratory setting, the heating means includes but is not limited to, heating mantles with external power sources, heating mantles with built-in (or interior) power sources, electric heat sources such as heat guns, heating baths (water, oil, and various organic baths, for example), and open flame, such as a Bunsen burner. In the field application of the present invention, the heating means includes but is not limited to any readily transportable heat source, including but not limited to electric heat sources (e.g., heat guns); electric heating means which can be supplied by remote, portable generators, batteries, automobiles, cigarette lighters, and the like; heating mantles, such as a heating mantle similar to a baby-bottle warmer adapted for use with a syringe/syringe barrel; open flame-based heating sources, such as oil burning burners or Bunsen burners; microwave and microwave-related heating means; and chemical heat sources, means, or processes, such as those heat sources which are generated by combining two or more chemicals for the express purpose of generating a controlled and/or sustained exotherm. For example, it is envisioned that at a crime scene, the rehydrating solution can be heated separately, then drawn into an injection apparatus and immediately injected into the tissue to be rehydrated with only minimal heat loss to the atmosphere. More preferably, the rehydrating solution can be added to an injection apparatus prior to heating; equally as acceptable, the rehydrating solution can be pre-packaged in an injection apparatus that is immediately ready for application (e.g, a disposable syringe). In this instance, the heating means can be a heating mantle or similar heating apparatus that provides a controlled heat to the injection apparatus for a period of time sufficient to bring the temperature of the solution to the desired temperature, e.g., about 50-60° C.

Upon heating the rehydrating solution to the desired temperature using an appropriate heating means, the tissue is exposed to the heated rehydrating solution. By the term “exposed”, we mean that the tissue is put in contact with the heated rehydrating solution, and encompasses such contacting means as soaking, bathing, injecting, and the like. If exposure of the tissue to the heated rehydrating solution is by soaking, it is preferred that the tissue be substantially covered by the solution for an appropriate amount of time to rehydrate the tissue. In the instance that exposure of the tissue to the rehydrating solution is by injection, injection can be by any suitable injection means known in the art. Such suitable injection means includes but is not limited to syringes having variable-gauge needles for direct injection, syringe-like apparati, and the like.

The exposure time needed for the practice of the present disclosure is generally on the order of between 1 and 30 minutes, although this time can be longer or shorter, depending upon several factors, including the degree of dehydration and the condition of the tissue to be rehydrated. Typically, if the rehydrating solution is to be injected, the exposure time is between about 1 minute and about 5 minutes, preferably between about 1 minute and about 3 minutes, and more preferably between about 1 minute and about 2 minutes. In the instance of exposing the tissue to be rehydrated by soaking the tissue in the rehydration solution, the exposure time is between about 1 minute and 60 minutes, preferably between about 1 minute and 30 minutes, and more preferably between about 1 minute and 10 minutes. When the tissue rehydration process of the present invention is practiced on living tissue, for example, a person's hand, then the exposure time is between about 1 minute and about 10 minutes, and more preferably between about 1 minute and about 5 minutes. Generally, in all cases of exposure time for the applications described and suggested within the present disclosure, the time of exposure can be about 1 minute, about 2 minutes, about 3 minutes, about 4 minutes, about 5 minutes, about 6 minutes, about 7 minutes, about 8 minutes, about 9 minutes, about 10 minutes, about 15 minutes, about 20 minutes, about 25 minutes, about 30 minutes, about 35 minutes, about 40 minutes, about 45 minutes, about 50 minutes, about 55 minutes, and about 60 minutes, and ranges between any two of these time values.

Upon rehydration of the tissue, identification and examination can be done by any means known in the art; for example, identification can be by any of the known ink-based identification methods, such as the ink-and-roll method or puttying the tissue prior to inking, then inking and rolling the rehydrated tissue. Analysis can also be by such means as DNA analysis, microscopic analysis, and the like, depending entirely upon the specifics of the case, and what particular types of analyses are required.

As an example of one embodiment of the present invention, a process for rehydrating tissue, especially at a remote site such as a crime scene, comprises the steps of procuring a suitable piece of tissue for rehydration, such as tissue that has been mummified or burned. A rehydrating solution that does not contain alcohol, such as TES solution available from BioCare Medical is then added to an apparatus suitable for injectable delivery of the rehydrating solution. The solution in the apparatus is then heated to a temperature in the range of about 50° C. to about 60° C. using a heating means, such as an electric heating mantle. Upon reaching the desired temperature, the heated rehydrating solution is exposed to the tissue to be rehydrated by injectable delivery. After approximately 1-2 minutes, the tissue can be further analyzed by appropriate methods, such as by printing.

Equally and acceptably, the process of the present disclosure can be practiced in the laboratory on both living tissue, and the tissue of a cadaver, e.g, a finger, a toe, or lips. In the instance of practicing the process of the present invention so as to enhance fingerprint ridge detail, a tissue sample such as a digit (e.g., finger or toe) removed from a cadaver is procured. A bath of rehydrating solution is prepared, using a non-alcohol containing, non-toxic rehydrating solution such as TES from BioCare Medical, and the bath of solution is heating to a temperature of about 35° C. to about 70° C. using an appropriate heating means, such as an electric heating mantle with a variable control unit attached in order to control the power and regulate the temperature. Upon the temperature of the rehydrating solution reaching the desired temperature, the tissue is exposed to the heated solution by, for example, substantially submerging the tissue for a period of time sufficient to rehydrate the tissue sample. The period of time necessary for exposure generally depends on the degree of rehydration needed, and can vary from times as long as 60 or 30 minutes to times as short as 1-5 minutes. Upon completion of the exposure, the tissue sample is dried, and then further analyzed using any number of known, acceptable means, such as fingerprinting.

Both of the above-described processes can be performed quickly and easily either on site at a crime-scene (e.g., at the crime scene where a cadaver is found), or in the laboratory. Additionally, because the process is mild, does not involve the use of harsh, toxic chemicals, and can be accomplished using soaking as well as direct injection, the process can be used with living individuals whose fingerprints have been destroyed or damaged due to burns and the like.

An alternative embodiment of the presently disclosed process is for use with living subjects in instances where the fingerprint ridge detail has been lost from their digits, such as burn survivors, and individuals employed in trades where their hands and fingertips are exposed to harsh, damaging environments (e.g., cement workers). This application is increasingly more important as an increased number of government institutions, schools, and hospitals require that employees have fingerprint records on file. The use of such a process as described herein would allow those individuals, who might not otherwise be able to comply, to meet this requirement.

In such an instance, a typical process comprises first cleaning the subject's hand, fingertips, or the tissue area to be rehydrated using appropriate, non-toxic cleaning means. A rehydrating solution is prepared for use by heating it to a temperature between 35° C. and 70° C. using an appropriate heating means, such as described in detail above. The subject's hand, fingers, or both is then immersed and soaked in the heated rehydrating solution for an appropriate amount of time, about 1-2 minutes, necessary to relax the skin tissues and cells and cause the identifying fingerprint ridge lines to be brought up. Inking and rolling the rehydrated digits can then attain useable fingerprints.

While not intending to be limiting in any way, it is envisioned that the process described herein can be used for other forensic-related tissue identifications where the tissue has been damaged due to burns, exposure to the elements, mummification, and the like. For example, other envisioned uses in the forensic arena include enhancing distinctive body marks, such as tatoos or birth marks, which may aid in identification of a body.

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLES

### Example 1

### Tissue Rehydration at a Crime Scene (Prophetic)

A case example is that of a murdered, unidentified 22-year-old Hispanic female whose remains are recovered in a steel 55-gallon drum which had been buried in a crawl space of a home in a residential neighborhood for more than 30 years. The body had been placed in a cardboard barrel with a steel top, and this barrel had been placed in a steel drum with more than 200 pounds of inert plastic pellets. Due to the nature of the body having been sealed in the drum, which offered an air-tight environment and complete protection of the deceased's remains from the outside world, the body is in a preserved, mummified stated. That is, the body, and the hand tissue, are very dry and brittle, and exhibited classic dehydration characteristics.

In order to speed up the identification process, a forensic technician on-scene prepares the left hand for rehydration and printing. A solution of TES rehydration fluid (BioCare Medical, Walnut Creek, Calif.) according to the present disclosure is drawn up into a syringe having a standard, 1.5 in. (4 cm) 20-gauge needle. The syringe is then placed in a portable syringe warmer, which warms the solution to a temperature of approximately 50-60° C. After warming to temperature, approximately 1.5 cc of the warm solution is injected into the fingertips of the hand, progressing from a point proximal to the last digit. After approximately 1 minute, the fingers have attained the desired fullness, and exhibit clear ridge enhancement.

The fingers are then inked using the rolling method, and the prints are immediately submitted to the fingerprint database. Within 3 hours, identification of the woman is achieved from information on file at the Immigration Department.

### Example 2

### Tissue Rehydration in the Laboratory

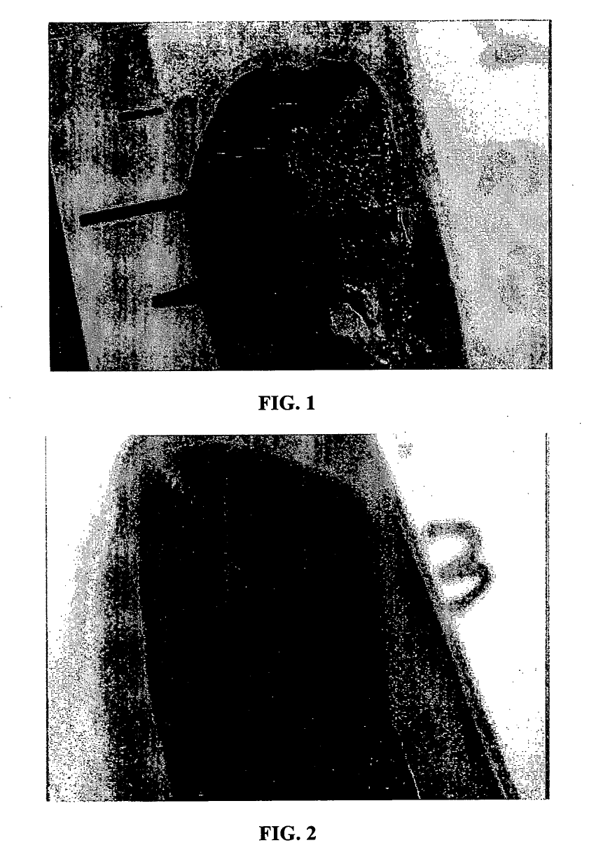

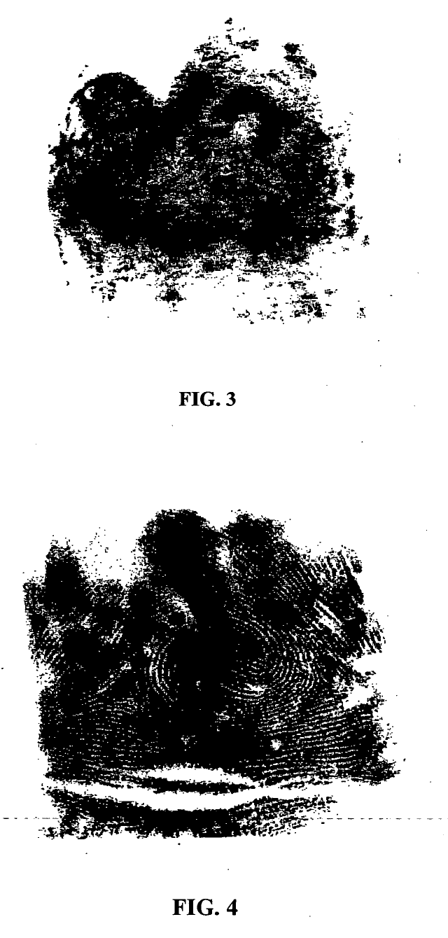

A digit from a cadaver that had been badly burned was received into the laboratory (FIG. 1). As the digit was more than 3 days old, an initial printing was attempted by powdering the fingertip region with putty (FIG. 3). After cleaning, the digit was injected, using a syringe with a 20-gauge needle, with 1 cc of Tissue Enhancing Solution (BioCare Medical) that had been heated to between 50-60° C. Within 2 minutes, the tissue showed significant visual evidence of rehydration (FIG. 2). This digit was then fingerprinted using the standard putty printing technique, providing a significantly enhanced print for use in identification of the cadaver (FIG. 4).

### Example 3

### Tissue Rehydration Using Soaking

An individual whose hands no longer carry identifiable fingerprints suitable for use in identification processes due to fourth degree burns covering the hands and lower arms first had their hands cleaned. The hand (or hands) to be softened were then submerged in a solution of tissue rehydrating solution in accordance with the requirements of the present invention that had been warmed to approximately 40° C. Complete submersion is preferable, to allow for rehydration of the palms as well as the digits for identification purposes. The tissue was soaked until it became pliant, approximately 1 minute.

Following the soaking, the hand was rinsed in cold water, in order to remove excess fluid. The hand was then gently dried, and the palm and digits were inked in the standard fashion (rolling), allowing viable prints to be obtained.

All of the compositions, methods, processes, and/or apparatus disclosed and claimed herein can be made and executed without undue experimentation in light of the present disclosure. While the compositions and methods of this invention have been described in terms of preferred embodiments, it will be apparent to those of skill in the art that variations may be applied to the compositions, methods, processes, and/or apparatus and in the steps or in the sequence of steps of the methods described herein without departing from the concept and scope of the invention. Additionally, it will be apparent that certain agents which are both chemically and physiologically related may be substituted for the agents described herein while the same or similar results would be achieved. All such similar substitutes and modifications apparent to those skilled in the art are deemed to be within the scope and concept of the invention.

1. A process for rehydrating tissue, comprising the steps of:
a) procuring tissue;
b) adding a rehydrating solution that does not contain alcohol to an apparatus suitable for injectable delivery of the solution;
c) heating the solution to a temperature of at least about 35° C. with a heating means; and
d) exposing the tissue to the heated solution to the tissue for a period of time.

2. The process of claim 1, wherein the rehydrating solution is a pH balanced, aqueous, salt-buffered solution containing an effective amount of low- or non-toxic biocide.

3. The process of claim 2, wherein the rehydrating solution is Tissue Enhancing Solution.

4. The process of claim 1, wherein the apparatus suitable for injectable delivery is a syringe.

5. The process of claim 1, wherein the heating means is a heating mantel.

6. The process of claim 1, wherein the temperature to which the solution is heated is in the range of about 35° C. to about 70° C.

7. The process of claim 6, wherein the temperature to which the solution is heated is about 50° C. to about 60° C.

8. The process of claim 1, wherein the tissue is exposed to the heated solution for about 1 minute to about 30 minutes.

9. A process for enhancing print ridge detail, comprising the steps of:
a) procuring a body part;
b) heating a rehydrating solution to a temperature of at least about 35° C. to about 70° C.; and
c) exposing the body part to the rehydration solution for a period of time sufficient to enhance print ridge detail.

10. The process of claim 9, wherein the exposing is done by injecting or soaking the body part.

11. The process of claim 9, wherein the rehydrating solution is a pH balanced, aqueous, salt-buffered solution containing an effective amount of low- or non-toxic biocide.

12. The process of claim 11, wherein the rehydrating solution is Tissue Enhancing Solution.

13. A method of obtaining prints for identification, the method comprising:
a) procuring a body part that can leave a print;
b) heating a rehydrating solution that does not contain a flammable fluid to a temperature of at least 35° C.; and
c) exposing the body part to the heated rehydrating solution for a period of time of at least 1 minute.

14. The method of claim 13, wherein the rehydrating solution is a pH balanced, aqueous, salt-buffered solution containing an effective amount of low- or non-toxic biocide.

15. The method of claim 14, wherein the rehydrating solution is Tissue Enhancing Solution.

16. The method of claim 13, further comprising printing the body part using an inking technique, the inking technique being selected from the group consisting of an inking-and-rolling technique or a puttying and taping technique.
